(19) United States
(12) Patent Application Publication
(10) Pub. No.: US 2016/0248585 A1
(43) Pub. Date: Aug. 25, 2016

(54) CRYPTOGRAPHIC APPARATUS AND METHOD

(71) Applicant: FUJITSU LIMITED, Kawasaki-shi (JP)

(72) Inventors: Jun Yajima, Kawasaki (JP); Kouichi ITOH, Kawasaki (JP)

(73) Assignee: FUJITSU LIMITED, Kawasaki-shi (JP)

(21) Appl. No.: 14/259,307

(22) Filed: Apr. 23, 2014

Related U.S. Application Data
(63) Continuation of application No. PCT/JP2011/075120, filed on Oct. 31, 2011.

(51) Int. Cl. H04L 9/30; G09C 1/00; H04L 9/00

(52) U.S. Cl. CPC H04L 9/3066; H04L 9/302; H04L 9/003; G09C 1/00

(57) ABSTRACT

A cryptographic apparatus and method is provided with which the circuit scale does not become large, even if a circuit that makes exposure of the secret key difficult by using Differential Power Analysis is equipped. First key data (dQ) representing a quotient obtained by exponentiating, with respect to respect prime data (pi), using respective random number setting data representing exponents (rpi) corresponding to respective prime data, and then obtaining multiplication data by multiplying the respective exponentiated data, and then dividing secret key data (d) by the multiplication data, and second key data (dR) representing a reminder obtained by dividing the secret key data by the multiplication data are stored in a storing unit in advance, and using the first key data and the second key data, a decryption process using RSA or ECC having a countermeasure against Differential Power Analysis (DPA) is performed.

### CROSS-REFERENCE TO RELATED APPLICATION

This application is a continuation application of International Application PCT/JP2011/075120 filed on Oct. 31, 2011 and designated the U.S., the entire contents of which are incorporated herein by reference.

### FIELD

The present invention relates to a cryptographic apparatus, method and program to execute cryptographic processing.

### BACKGROUND

In the recent years, the importance of the information security technology has been increasing more than ever. In addition, as a basic technology of the information security, public key cryptography has been studied actively. There are several types of public key cryptography, and algorithms such as the Rivest Shamir Adleman (RSA) encryption, Diffie-Hellman (DH) key exchange that use the modular exponentiation operation, and the Elliptic Curve Cryptography that uses the scalar multiplication on a point on the elliptic curve have been known.

RSA and DH are explained. In RSA and DH use a process called modular exponentiation operation. The modular exponentiation operation is an operation to calculate z=a^{x} mod n with respect to a base a, an exponent x, a modulus n. In RSA, a process in which the exponent x is made secret information is used. For example, in the decryption operation in RSA, the decryption process is performed by calculating m that satisfies m=c^{d} mod n from an encrypted text c (encrypted data), a private key (secret key data) d, a modulus n (public key data). For example, in the electronic signature, an electronic signature m is obtained by calculating from the signature object data c, the private key d, the modulus n. In any process, a third party who does not know the value of the private key d is not able to perform a correct decryption process or calculation of the electronic signature process result.

In m=c^{d} mod n, d is the private key, and is a value that must not be leaked to a fraudulent third party such as an attacker. That is, in RSA, the protection of the value of the private key d is important, and therefore there is a need for a protection by the tamper resistant function. In terms of mathematics, it has been known as a problem that, even if the values other than the private key d are known in m=c^{d} mod n, since the amount of calculation to calculate the private key d is too large, it is difficult to obtain the private key d within a realistic period of time (discrete logarithm problem). It has been known that, in the case of m=c^{d} mod n, when n is a value equal to or other than 1024 bits, it is difficult for an attacker to obtain the value of d, even if the attacker knows the value of c, n, m.

In addition, in DH, the modular exponentiation operation is also used. A common key K is obtained using K=A^{x} mod p with respect to the counterpart's public key A (=g^{y}:y is a counterpart's private key). There, x is a private key, and is a value that must not be leaked to a fraudulent third party such as an attacker. That is. in DH, the protection of the value of the private key x is important, and therefore there is a need for a protection by the tamper resistant function. It has been known that, in the case of K=A^{x} mod p. when p is a value equal to or larger than 1024 bits, it is difficult for an attacker to obtain the value of x, even if the attacker knows the value of K, A, p.

The Elliptic Curve Cryptography: ECC is explained.

In ECC, an operation using a process called scalar multiplication of a point (Elliptic Scalar Multiplication). The scalar multiplication is a process to calculate a point V on the elliptic curve that satisfies V=xA, from an integer x called a scalar value. In the same manner as the RSA encryption, a process in which x is made secret information is performed. For example, in the case of the Elliptic Curve Diffie-Hellman (ECDH) key exchange, assuming a point on the elliptic curve to be the public key of the communication counterpart as A, and the private key (secret key data) as d, by calculating the point V on the elliptic curve that satisfies V=dA, a secure key sharing is realized. A third party who does not know the value of the private key d is not able to calculate the value of the common key.

Meanwhile, in V=dA, d is the private key, and is a value that must not be leaked to a fraudulent third party such as an attacker. That is. in the ECC, the protection of the value of d is important, and therefore there is a need for a protection by the tamper resistant function. In terms of mathematics, it has been known as a problem that, even if the values other than the private key d are known in V=dA, since the amount of calculation to calculate the private key d is too large, it is difficult to obtain the private key d within a realistic period of time (discrete logarithm problem). It has been known that, when the elliptic curve parameter is equal to or larger than 160 bits, it is difficult to obtain the value of the private key d even when the value of A, V is known.

However, in recent years, there are several attacking methods to expose the private key, and for example, as a kind of the side channel attack, a method to expose the secret key using the Differential Power Analysis: DPA. The DPA is a method in which the power consumption of a electronic device (ex. smart card) and the during processing is measured, and the difference between the plurality of measured power waveforms is used to expose the private key.

As a countermeasure against the attack using the DPA, a method to perform cryptographic processing using data randomization has been known. In the cryptographic processing using data randomization, when calculating m=c^{d} mod n, a random number r is generated every time. Then, the exponent d is expressed as d=d′×r+d″, and assuming d′=quotient of d÷r and d″=reminder of d÷r, the calculation is performed with every cryptographic processing using a divider. Then, a modular exponentiation operator including a multiplication reminder operator executes the process to obtain the process result. That is, in d=d′×r+d″, the value of r changes with every process, and the values of d′, d″ change with every process. Therefore, it follows that the exponent in c^{r} mod N, (c′)^{d′} mod N, c^{d″} mod N change every time with the processing, and the power waveform also changes every time, and therefore, the correlation between the power consumption and the private key disappears, and secure cryptographic processing may be performed against the DPA.

In addition a method to use a Montgomery multiplication reminder operator instead of the multiplication reminder operator has been disclosed.

Japanese National Publication of International Patent Application No. 2003-518872

Japanese Laid-open Patent Publication No. 2006-276786

### SUMMARY

According to an aspect of the embodiment, A cryptographic apparatus includes a storing unit, a random number generating unit, and an modular exponentiation operating unit. The cryptographic apparatus obtains decrypted data by an modular exponentiation operation using encrypted data representing a base, secret key data representing an exponent and public key data representing a modulus.

The storing unit stores first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data.

The random number generating unit obtains second random number data by exponentiating the respective prime data, using respective first random number data being positive integers equal to or smaller than the random number setting data representing exponents corresponding to the respective prime data and by multiplying the respective obtained exponentiated data. The random number generating unit obtains tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data.

The modular exponentiation operating unit obtains a first variable (d′) by performing a multiplication reminder operation using the first key data and the tamper resistant data as a base with data obtained by subtracting 1 from a maximum bit width length that may be handled in the multiplication reminder operation as a modulus or to obtain the first variable by multiplication of the first key data and the tamper resistant data. Alternatively, the first variable (d′) may be obtained by multiplication of the first key data and the tamper resistant data. The modular exponentiation operating unit obtains a second variable (c′) by performing a modular exponentiation operation with the encrypted data as a base, with the second random number data as an exponent and with the public key data as a modulus. The modular exponentiation operating unit obtains a third variable (t) by performing a modular exponentiation operation with the second variable as a base, with the first variable as an exponent, and with the public key data as a modulus. The modular exponentiation operating unit obtains a fourth variable (u) by performing a modular exponentiation operation with the encrypted data as a base, with the second key data as an exponent, and with the public key data as a modulus. The modular exponentiation operating unit obtains the decrypted data by performing a multiplication reminder operation with the third variable and the fourth variable as a base and with the public key data as a modulus.

In addition, the modular exponentiation operating unit obtains the first variable (d′) by performing a Montgomery multiplication reminder operation using the first key data and the tamper resistant data as a base with data obtained by subtracting 1 from 2 raised to the power of a maximum bit width length that may be handled in the Montgomery multiplication reminder operation as the modulus. Alternatively, the first variable (d′) may be obtained by multiplication of the first key data and the tamper resistant data. The modular exponentiation operating unit obtains a fifth variable (m′) by performing a Montgomery multiplication reminder operation using the third variable and the fourth variable as a base and with the public key data as a modulus. The modular exponentiation operating unit obtains the encrypted data by performing a Montgomery multiplication reminder operation using the fifth variable and a square of a Montgomery parameter as a base with the public key data as a modulus. The order of the process to obtain the second variable and the third variable and the process to obtained the fourth variable may be inversed.

According to an aspect of the embodiment, A cryptographic apparatus includes a storing unit, a random number generating unit, a multiplication unit and a point scalar multiplication operating unit, the cryptographic apparatus obtains decrypted data by a point scalar multiplication operation using encrypted data, secret key data and public key data.

The storing unit stores first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data.

The random number generating unit obtains second random number data by exponentiating the respective prime data, using respective first random number data being positive integers equal to or smaller than the random number setting data representing exponents corresponding to the respective prime data and by multiplying the respective obtained exponentiated data. The random number generating unit obtains tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data.

The multiplication unit obtains the first variable (d′) by performing a multiplication using the first key data and the tamper resistant data. Alternatively, then a Montgomery multiplication reminder operating unit is provided, the Montgomery multiplication reminder operating unit obtains the first variable (d′) by Montgomery multiplication reminder operation using the first key data and the tamper resistant data as the base, and with data obtained by subtracting 1 from the maximum bit width that may be handed in Montgomery multiplication reminder operation as the modulus. There may be a case in which the multiplication unit, the Montgomery multiplication reminder operating unit are included in the point scalar multiplication unit.

The point scalar multiplication operating unit obtains the second variable (c′) by performing a point scalar multiplication operation using the encrypted data and the second random number data. The point scalar multiplication operating unit obtains the third variable (t) by performing a point scalar multiplication using the second variable and the first variable. The point scalar multiplication operating unit obtains the fourth variable (u) by performing a point scalar multiplication using the encrypted data and the second key data. The order of the process to obtain the second variable and the third variable and the process to obtained the fourth variable may be inversed. Next, the point scalar multiplication operating unit obtains decrypted data by performing a point addition operation using the third variable and the fourth variable.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the hardware of an cryptographic apparatus.

FIG. 2 is a diagram illustrating an example of a control unit.

FIG. 3 is a flow diagram illustrating an example of the operation of a generating process of data used for cryptographic processing.

FIGS. 4A and 4B are diagrams illustrating an example of the data structure of the pre-generated information.

FIG. 5 is a flow diagram illustrating an example of the operation of cryptographic processing.

FIGS. 6A, 6B and 6C are diagrams illustrating an example of the data structure of cryptographic processing information.

FIG. 7 is a diagram illustrating an example of a control unit of embodiment 2.

FIG. 8 is a flow diagram illustrating an example of the operation of cryptographic processing in embodiment 2.

FIGS. 9A, 9B, 9C, 9D, and 9E are diagrams illustrating an example of data structure of pre-generated information and cryptographic processing information in embodiment 2.

FIG. 10 is a diagram illustrating an example of a control unit in embodiment 3.

FIG. 11 is a flow diagram illustrating an example of the operation of cryptographic processing in embodiment 3.

FIGS. 12A, 12B, 12C, 12D, and 12E are diagrams illustrating an example of the data structure of pre-generated information and cryptographic processing information.

### DESCRIPTION OF EMBODIMENTS

With the cryptographic apparatus explained in each embodiment, it becomes possible not to make the circuit scale large, even when it is equipped with a circuit that performs data randomization to make the decryption of the secret key using the Differential Power Analysis (DPA). In addition, when realizing the cryptographic processing performed in the cryptographic apparatus by a computer, a program including cryptographic processing may be executed using the computer.

Meanwhile, as the cryptographic apparatus, an integrated circuit (IC) card, an IC chip (an integrated circuit) or a circuit board (a printed circuit board and the like) mounted on an embedded device with an authentication function, and the like, are possible.

Hereinafter, details of the embodiments are described based on the drawings.

embodiment 1 is explained.

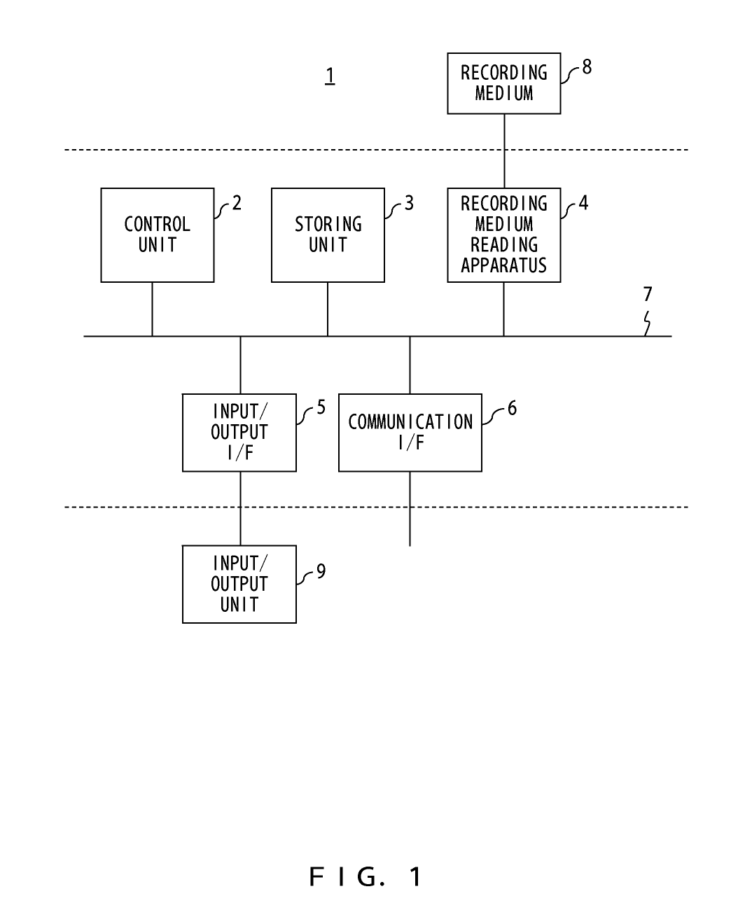

embodiment 1 is an application, to the hardware in FIG. 1, of cryptographic processing to which the Rivest Shamir Adleman (RSA) encryption is applied. meanwhile, for the modular exponentiation operation used in the RSA encryption, in order to reduce the amount of calculation to log₂ d, the binary method is used.

In the modular exponentiation, for example, when the modular exponentiation is simply calculated when all of the public key data n, encrypted data c, secret key data d have a length of equal to or longer than 1024 bits (not limited to 1024), d times of multiplication using mod n is needed, and this is not realistic as an amount of calculation of 2¹⁰²⁴ or more is required. Then, in order to reduce this amount of calculation to log₂ d, the binary method is used. The binary method in the modular exponentiation scans the bit value d[i] of the secret key data d in the order from the higher-order bits to the lower-order bits, when the secret key data of u bits are expressed as d[u−1]∥ . . . ∥d[1]∥d[0]. That is, the scan is performed in the order from i=u−1 to i=0. Here, d[i] is the i-th bit from the lowest-order of d, where i≧0. Meanwhile, “∥” represents the concatenation of bit strings. Next, according to the bit value d[i] of the secret key data d, when d[i]=1, multiplication (v:=v×a(mod n)) is performed after square calculation (v:=v×v(mod n)), and when d[i]=0, only square calculation (v:=v×v(mod n)) is performed. Meanwhile, for this part, a general algorithm to process the modular exponentiation operation at a high speed such as the window method may also be used.

FIG. 1 is a diagram illustrating an example of the hardware of the cryptographic apparatus. When the cryptographic apparatus is an integrated circuit, the cryptographic apparatus includes a control unit 2, a storing unit 3, a communication interface 6 and the like, and a configuration in which the control unit 2, storing unit 3, communication interface 6 are respectively connected by a bus 7 is desirable.

In addition, when built on the circuit board of the cryptographic apparatus, a configuration in which a control unit 2, a storing unit 3, a recording medium reading apparatus 4, a input/output interface 5 (input/output I/F), a communication interface 6 (communication I/F) are provide, and the respective constituent elements are connected by a bus 7 is desirable. Meanwhile, the recording medium reading apparatus 4 does not have to be provided. In addition, only one of the input/output interface 5 or the communication interface 6 may be provided.

The control unit 2 includes a processing unit 201 (processing circuit), a random number generating unit 202 (random number generating circuit), an modular exponentiation operating unit 203 (modular exponentiation operating circuit), a multiplication reminder operating unit 204 (multiplication reminder operating circuit) and the like described later.

In addition, the control unit 2 is possible to use a Central Processing Unit a (CPU) and a multi-core CPU and the like for. In addition, as the control unit 2, a programmable device (Field Programmable Gate Array (FPGA), Programmable Logic Device (PLD) and the like).

The storing unit 3 stores the pre-generated information, cryptographic processing information and the like described later. As the storing unit 3, for example, a memory and hard disc and the like such as a Read Only Memory (ROM), Flash-ROM, Random Access Memory (RAM), FeRAM are possible. Meanwhile, the storing unit 3 may record data of the parameter value, the variable value and the like, and may be used as a work area at the time of execution. In addition, in the storing unit 3 (a non-volatile memory such as a ROM, Flash-ROM, FeRAM) is stored a program which is read out by the control unit at the time of the execution to execute the process.

The recording medium reading apparatus 4 controls read/write of data to a recording medium 8, according to the control by the control unit 2. Then, it makes data written in by the control by the recording medium reading apparatus 4 recorded in the recording medium 8, and makes the data recorded in the recording medium 8 read out. In addition, for the attachable/detachable recording medium 8, as a computer-readable non-transitory recording medium, there are a magnetic recording device, an optical disc, a magneto-optical recording medium, a semiconductor memory and the like. As the magnetic recording device, there is a hard disc device (HDD) and the like. As the optical disc, there are a Digital Versatile Disc (DVD), DVD-RAM, Compact Disc Read Only Memory (CD-ROM), CD-R (Recordable)/RW (ReWritable) and the like. As the magneto-optical recording medium, there is a Magneto-Optical disc (MO) and the like. Meanwhile, the storing unit 3 is also included in the non-transitory recording medium.

Meanwhile, the recording medium, the recording medium reading apparatus are not indispensable.

To the input/output interface 5, an input/output unit 9 such as a personal computer is connected, and it receives information input by the user (for example, data such as encrypted data, public key data), and transmits it to the control unit 2 or the storing unit 3 and the like via the bus 7. As the input device of the input/output unit 9, for example, a keyboard, a pointing device (a mouse and the like), a touch panel and the like are possible. Meanwhile, as the display being the output unit of the input/output unit 9, for example, a liquid-crystal display and the like is possible. In addition, the output unit may also be an output device such as a Cathode Ray Tube (CRT) display, a printer and the like.

The communication interface 6 is an interface for performing the Local Area Network (LAN) connection, Internet connection, and wireless connection. In addition, the communication interface 6 is an interface for performing the LAN connection, Internet connection and wireless connection with another computer as needed. In addition, it is connected to another device, and controls input/output of data from the external device.

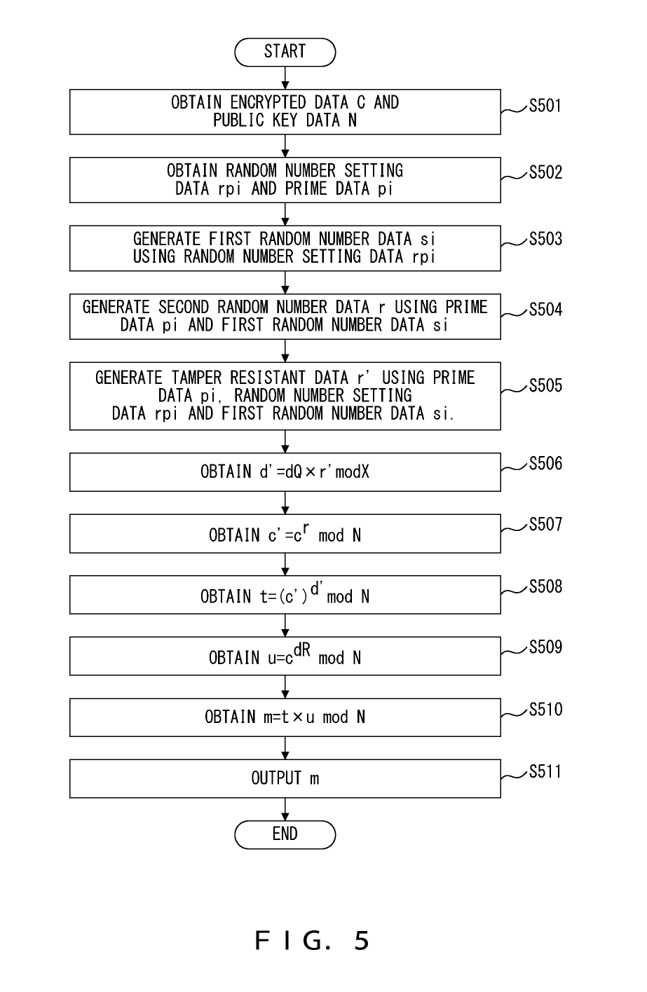

In addition, by using the computer having the hardware configuration described above, various processing functions described later (for example, the flow illustrated in FIG. 5) may be realized. In that case, a program describing the processing content of the function that the computer is supposed to have is provided. By executing the program by the computer, the processing functions are realized on the computer. The program describing the processing content may be recorded in the computer-readable recording medium 8.

When distributing a program, for example, the recording medium 8 such as a DVD, CD-ROM and the like on which the program is recorded is sold. In addition, the program may be recorded in a storing device of a server computer, and the program may be forwarded from the server computer to another computer via a network.

The computer executing the program records the program recorded on the recording medium 8 or the program forwarded from the server computer in the storing unit 3 of its own, for example. Then, the computer reads out the program of the storing unit 3 of its own, and executes the process according to the program.

The control unit 2 is explained.

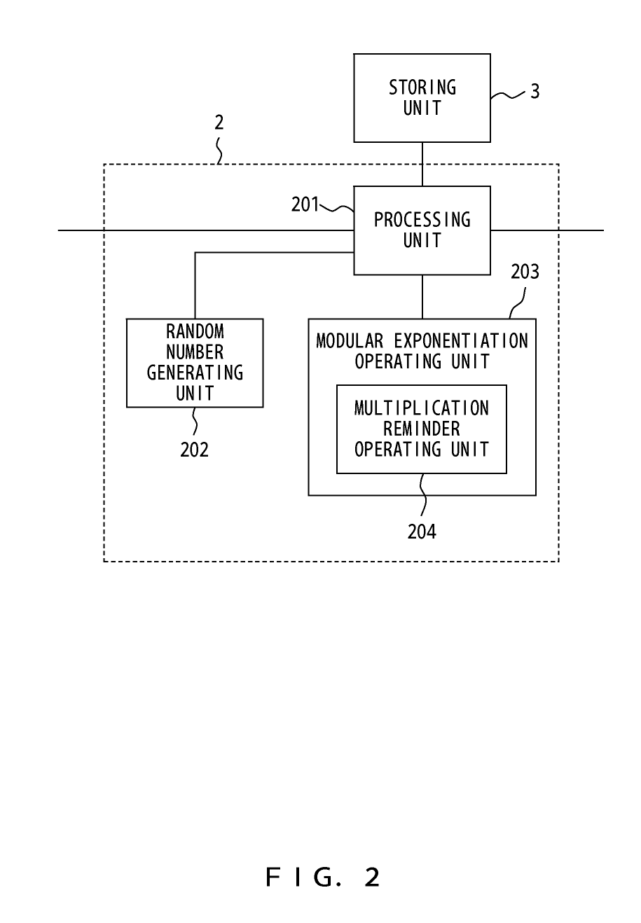

FIG. 2 is a diagram illustrating an example of the control unit. The control unit 2 in FIG. 2 includes a processing unit 201 (processing circuit), a random number generating unit 202 (random number generating circuit), an modular exponentiation operating unit 203 (modular exponentiation operating circuit), a multiplication reminder operating unit 204 (multiplication reminder operating circuit) and the like.

The processing unit 201 obtains the encrypted data c and the public key data N through the input/output interface 5 or the communication interface 6, and stores the encrypted data c and the public key data N in the storing unit 3. Alternatively, there may be a case in which the encrypted data c and the public key data N are stored in the storing unit 3 in advance.

Meanwhile, the processing unit 201 obtains random number setting data rpi (i=0−n:n is a positive integer) and prime data pi(i=0−n:n is a positive integer). In addition, decrypted data m is obtained from the storing unit 3, and the decrypted data m is output via the input/output interface 5 or the communication interface 6.

The random number generating unit 202 generates the first random number data si (i=0−n:n is a positive integer) using the random number setting data rpi. When the random number generating unit 202 generates the first random number data si, the value with respect to each i for the first random number data si is supposed to satisfy 0≦si≦rpi. Next, the random number generating unit 202 stores the obtained first random number data si in the storing unit 3 through the processing unit 201. In addition, the random number generating unit 202 generates the second random number data r using the prime data pi and the first random number data si. The second random number data r is obtained using expression 2 described later. In addition, the random number generating unit 202 generates tamper resistant data r′ using the prime data pi and the random number setting data rpi and the first random number data si. The tamper resistant data r′ is obtained using expression 3 described later. Next, the random number generating unit 202 stores the obtained tamper resistant data r′ in the storing unit 3. Meanwhile, the tamper resistant data r′ may be generated and stored, in the storing unit 3, by the processing unit 201.

The modular exponentiation operating unit 203 obtains a variable c′ (the second variable) with the encrypted data c in the storing unit 3 as the base, the second random number data r as the exponent, and the public key data N as the modulus. The variable c′ is obtained using expression 5 described later. In addition, the modular exponentiation operating unit 203 obtains a variable t (the third variable) with the variable c′ in the storing unit 3 as the base, the variable d′ as the exponent, and the public key data N as the modulus. The variable t is obtained using expression 6 described later. Next, the modular exponentiation operating unit 203 stores the obtained variable t in the storing unit 3. In addition, the modular exponentiation operating unit 203 obtains a variable u (the fourth variable) with the encrypted data c in the storing unit 3 as the base, the second key data dR as the exponent, and the public key data N as the modulus. The variable u is obtained using expression 7 described later. Next, the modular exponentiation operating unit 203 stores the obtained variable u in the storing unit 3.

The multiplication reminder operating unit 204 obtains a variable d′ (the first variable) by executing the multiplication reminder operation using the first key data dQ and tamper resistant data r′ in the storing unit 3, with X representing the bit length of the modulus that is processable by the multiplication reminder operating unit as modulus. The variable d′ is obtained using expression 4. Meanwhile, d′ may be obtained by the processing unit by the multiplication of dQ and r′. The multiplication reminder operating unit 204 obtains decrypted data by executing the multiplication reminder operation using the variable t and the variable u in the storing unit 3, with the public key data N as the modulus. The decrypted data m is obtained using expression 8 described later. Next, the multiplication reminder operating unit 204 stores the decrypted data m in the storing unit 3.

The generating process of data used for the cryptographic processing is explained.

The generating process is a process to obtain data required when the cryptographic apparatus performs the cryptographic processing, and is executed by, for example, using a computer and the like. As the computer, for example, it is possible to use a personal computer, a server and the like. In addition, the process may be performed in advance inside the cryptographic apparatus.

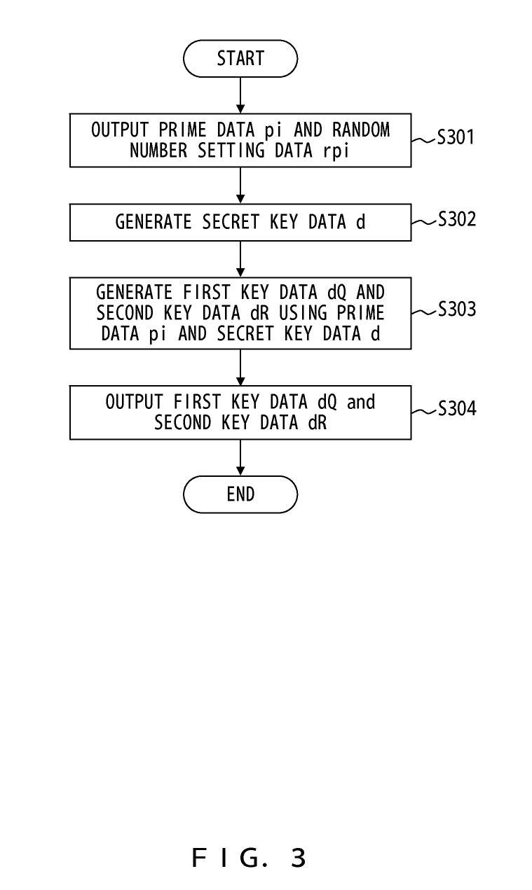

FIG. 3 is a flow diagram illustrating an example of the operation of the generating process of data used for the cryptographic processing.

In step S301, the computer outputs the prime data pi and the random number setting data rpi decided by the user to the storing unit 3 or the random number generating unit 202 through the communication interface 6 or the processing unit 201 of the cryptographic apparatus 1. When the processing is performed inside the cryptographic apparatus, this process is omitted. Each prime data pi (i=0−n:n is a positive integer) is supposed to be a prime. For example, when n=3, p0=2, p1=3, p2=5 are possible. Each random number setting data rpi (i=0−n:n is a positive integer) is supposed to be a positive integer. For example, rp0=3, rp1=2, rp2=2 are possible, when n=3.

In step S302, the computer of the cryptographic apparatus generates the secret key data d. The secret key data d is obtained by, for example, making a program having a known key-generating algorithm by a computer. For example, as the secret key data d, a positive integer such as 7067 is possible.

In step S303, the computer or the cryptographic apparatus generates the first key data dQ and the second key data dR using the prime data pi and the secret key data d. The first key data dQ and the second key data dR may be expressed by the expression 1.

d=dQ×(p0^{rp0}×p1^{rp1}×p2^{rp2}× . . . ×p2^{rpn})+dR expression 1
dQ:quotient of d/(p0^{rp0}×p1^{rp1}×p2^{rp2}× . . . ×p2^{rpn})
dR: reminder of d/(p0^{rp0}×p1^{rp1}×p2^{rp2}× . . . ×p2^{rpn})
pi:prime data
rpi:random number setting data

At this time, when the processing is performed by the cryptographic apparatus, the process can be performed at a high speed by, for p0^{rp0}×p1^{rp1}×p2^{rp2}× . . . ×p2^{rpn}, storing a pre-calculated one in the storing unit.

For example, when the secret key data d=7067, the prime data p0=2, p1=3, p2=5, random number setting data rp0=3, rp1=2, rp2=2, the first key data dQ is the quotient 3 of the division of 7067 by 1800 (=2³×3²×5²). The second key data dR is the reminder 1667 of the division of 7067 by 1800.

In step S304, the computer outputs the first key data dQ and the second key data dR to the storing unit 3 through the communication interface 6 or the processing unit 201 of the cryptographic apparatus 1.

By the generating process described above, the prime data pi and the random number setting data rpi are stored in the storing unit 3 or the random number generating unit 202 of the cryptographic apparatus 1, and the first key data dQ and the second key data dR are stored in the storing unit 3.

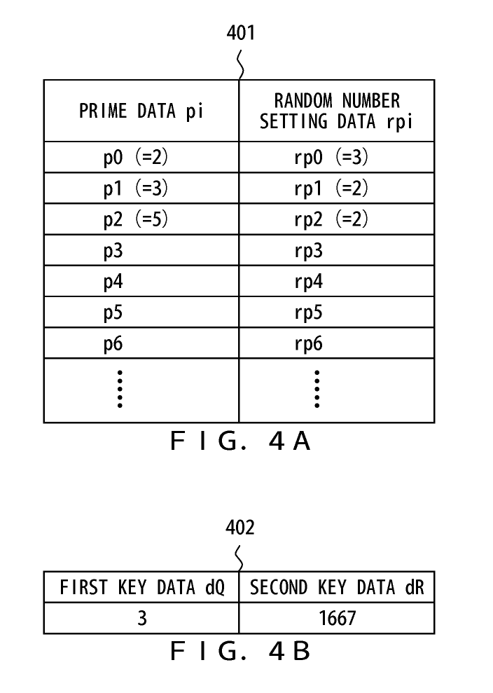

FIGS. 4A and 4B present a diagram illustrating an example of the data structure of pre-generated information.

Pre-generated information 401, 402 includes information stored in the “prime data pi” “random number setting data rpi” “first key data dQ” “second key data dR”. In the “prime data pi” of the pre-generated information 401, the prime data output in the generating process is stored, and in this example, “p0” “p1” “p2” “p3” “p4” “p5” “p6” . . . are stored. Meanwhile, (=2), (=3), (=5) indicated in “p0” “p1” “p2” represent the three pieces of prime data p0-p2 explained above, respectively.

In the “random number setting data rpi”, of the pre-generated information 401, the random number setting data output in the generating process is stored, and in this example, “rp0” “rp1” “rp2” “rp3” “rp4” “rp5” “rp6” . . . are stored. Meanwhile, (=3), (=2), (=2) indicated in “rp0” “rp1” “rp2” represent the value of the three pieces of random number setting data rp0-rp2 explained above, respectively.

In the “first key data dQ” of pre-generated information 402, the first key data output in the generating process is stored, and in this example. “3” is stored. In the “second key data dR”, the second key data output in the generating process is stored, and in this example, “1667” is stored.

Meanwhile, while the case in which the pre-generated information 401, 402 are in the storing unit 3 is explained in this example, the information stored in the “prime data pi” “random number setting data rpi” may be stored in the random number generating unit 202.

The cryptographic processing is explained.

FIG. 5 is a flow diagram illustrating an example of the operation of the cryptographic processing.

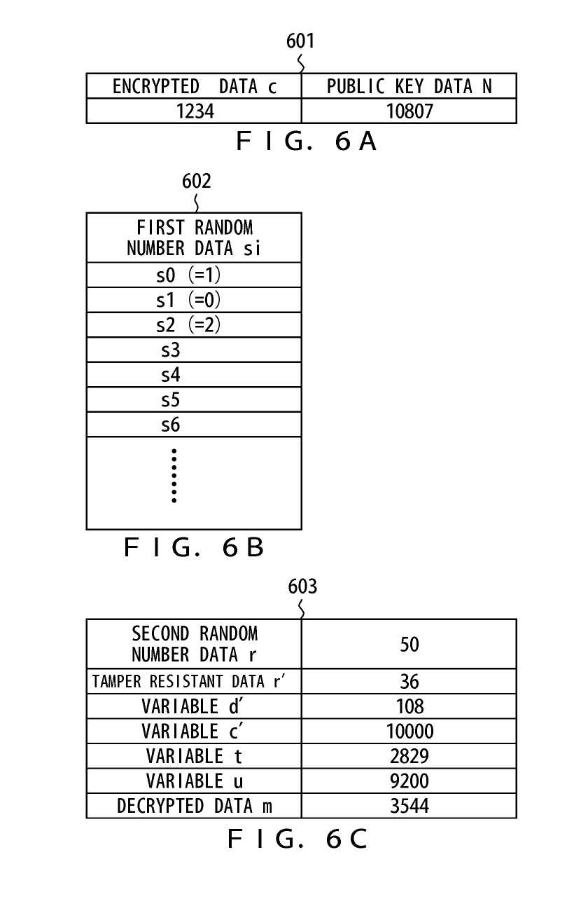

In step S501, the processing unit 201 of the control unit 2 obtains the encrypted data c and the public key data N through the input/output interface 5 and the communication interface 6. For example, it is assumed that encrypted data c=1234 and public key data N=10807 are obtained. Next, the processing unit 201 stores the encrypted data c and the public key data N in the storing unit 3. There may be a case in which c, N are stored in the storing unit in advance. See the cryptographic processing information 601 in FIG. 6A. FIG. 6A, FIG. 6B, FIG. 6C are diagrams illustrating an example of the data structure of the cryptographic processing information. The cryptographic processing information 601 in FIG. 6A includes information stored in the “encrypted data c” “public key data N”. In this example, the encrypted data c “1234” and the public key data N “10807” are stored.

In step S502, the processing unit 201 of the control unit 2 obtains the random number setting data rpi and the prime data pi from the pre-generated information 401 of the storing unit 3. For example, it is assumed that, random number setting data rp0=3, rp1=2, rp2=2, prime data p0=2, p1=3, p2=5 are obtained.

In step S503, the random number generating unit 202 of the control unit 2 generates the first random number data si (i=0−n:n is a positive integer) using the random number setting data rpi. When the random number generating unit 202 generates the first random number data si, the value with respect to each i for the first random number data si is supposed to satisfy 0≦si≦rpi. For example, when the random number setting data is rp0=3, rp1=2, rp2=2, the first random number data s0=1 (0≦s0≦3), s1=0(0≦s1≦2), s2=2(0≦s2≦2) are possible. Next, the random number generating unit 202 stores the obtained first random number data si in the storing unit 3 via the processing unit 201. See the cryptographic processing information 602 in FIG. 6B. The cryptographic processing information 602 in FIG. 6B includes information stored in “the first random number data si”. In this example, “s0” “s1” “s2” “s3” “s4” “s5” “s6” . . . are stored. Meanwhile, (=1), (=0), (=2) indicated in “s0” “s1” “s2” represent the value the three first random number data s0-s2, respectively.

In step S504, the random number generating unit 202 of the control unit 2 generates the second random number data r using the prime data pi and the first random number data si. The second random number data r is obtained using expression 2.

r=p0^{s0}×p1^{s1}×p2^{s2}× . . . ×pn^{sn} expression 2
r:second random number data
pi:prime data
si: first random number data

For example, when the prime data is p0=2, p1=3, p2=5 and the first random number data is s0=1, s1=0, s2=2, the second random number data r is obtained by calculating 2¹×3⁰×5²=50. Next, the random number generating unit 202 stores the obtained second random number data r in the storing unit 3. See the cryptographic processing information 603 in FIG. 6C. The cryptographic processing information 603 in FIG. 6C includes information stored in “second random number data r” “tamper data r′” “variable d′” “variable c′” “variable t” “variable u” “decrypted data m”. In this example, “50” “36” “108” “10000” “2829” “9200” “3544” corresponding to “second random number data r” “tamper data r′” “variable d′” “variable c′” “variable t” “variable u” “decrypted data m” are stored. “second random number data r” stores the second random number data r obtained in step S504. Information stored in each of “tamper resistant data r′” “variable d′” “variable c′” “variable t” “variable u” “decrypted data m” is described later.

In step S505, the random number generating unit 202 or the processing unit 201 generates the tamper resistant data r′ using the random number setting data rpi and the first random number data si. The tamper resistant data r′ is obtained using expression 3.

r′=p0^{rp0-s0}×p1^{rp1-s1}×p2^{rp2-s2}× . . . ×pn^{rpn-sn} expression 3
r′:tamper resistant data
pi:prime data
si:first random number data
rpi:random number setting data

For example, when the prime data is p0=2, p1=3, p2=5 and the first random number data is s0=1, s1=0, s2=2, and the random number setting data is rp0=3, rp1=2, rp2=2, the tamper resistant data r′ is obtained by calculating 2³⁻¹×3²⁻⁰×5²⁻²=36. Next, the random number generating unit 202 or the processing unit 201 stores the obtained tamper resistant data r′ in the storing unit 3. In “tamper resistant data r′” of the cryptographic processing information 603 in FIG. 6C, “36” stored in step S505 is stored.

In step S506, the multiplication reminder operating unit 204 of the control unit 2 obtains variable d′ using the first key data dQ and the tamper resistant data r′. The variable d′ is obtained using expression 4.

d′=dQ×r′ mod X expression 4
dQ:the first key data
r′:tamper resistant data
X:2^{(bl)-1}

Here, above-mentioned bl:the bit length of the modulus processable by the multiplication reminder operating unit. For example, when the first key data dQ is 3 and the tamper resistant data r′ is 36, and the bit length of the modulus (public key data N:modulus) processable by the multiplication reminder operating unit 204 is 16 bits, the variable d′ is obtained by calculating 3×36 mod 0xFFFF=108. Here, 0xFFFF is a number expressing 2¹⁶−1 in hexadecimal notation. Next, the multiplication reminder operating unit 204 stores the obtained variable d′ in the storing unit 2. Also, d′ may be obtained by the multiplication of dQ and r′ in the processing unit. In “variable d′” in the cryptographic processing information 603 in FIG. 6C, “108” obtained in step S506 is stored.

In step S507, the modular exponentiation operating unit 203 of the control unit 2 obtains variable c′ using the encrypted data c and the second random number data r and the public key data N in the storing unit 3. The variable c′ is obtained using expression 5.

c′=c^{r} mod N expression 5
c:encrypted data
r:the second random number data
N:public key data

For example, when the encrypted data c is 1234, the second random number data r is 50, and the public key data N is 10807, the modular exponentiation operating unit 203 obtains the variable c′ by calculating (1234)⁵⁰ mod 10807=10000. Next, the modular exponentiation operating unit 203 stores the variable c′ in the storing unit 3. In “variable C′” of the cryptographic processing information 603 in FIG. 6C, “1000” obtained in step S507 is stored.

In step S508, the modular exponentiation operating unit 203 in the control unit 2 obtains the variable t using the variable c′ and the variable d′ and the public key data N in the storing unit 3. The variable t is obtained using the expression 6.

t=(c′)^{d′} mod N expression 6
N:public key data

For example, when the variable c′ is 10000, the variable d′ is 108, and the public key data N is 10807, the modular exponentiation operating unit 203 obtains the variable t by calculating (10000)¹⁰⁸ mod 10807=2829. Next, the modular exponentiation operating unit 203 stores the obtained variable t in the storing unit 3. In “variable t” of the cryptographic processing information 603 in FIG. 6C, “1000” obtained in step S508 is stored.

In step S509, the modular exponentiation operating unit 203 of the control unit 2 obtains the variable u using the encrypted data c and the second key data dR and the public key data N in the storing unit 3. The variable u is obtained using expression 7.

u=c^{dR} mod N expression 7
c:encrypted data
dR:the second key data
N:public key data

For example, when the encrypted data c is 1234, the second key data dR is 1667, and the public key data N is 10807, the modular exponentiation operating unit 203 obtains the variable u by calculating (1234)¹⁶⁶⁷ mod 10807=9200. Next, the modular exponentiation operating unit 203 stores the obtained variable u in the storing unit 3. In “variable u” of the cryptographic processing information 603 in FIG. 6C, “9200” obtained in step S509 is stored.

The order of steps S502-S508 and S509 may be changed. In step S510, the multiplication reminder operating unit 204 of the control unit 2 obtains decrypted data m using the variable t and the variable u and the public key data N in the storing unit 3. The decrypted data m is obtained using expression 8.

m=t×u mod N expression 8
N:public key data

For example, when the variable t is 2829, the variable u is 9200, and the public key data N is 10807, the multiplication reminder operating unit 204 obtains decrypted data m by calculating (2829×9200) mod 10807=3544. Next, the multiplication reminder operating unit 204 stores the decrypted data m obtained in the storing unit 3. In “decrypted data m” of the cryptographic processing information 603 in FIG. 6C, “3544” obtained in step S510 is stored.

In step S511, the control unit 2 obtains the decrypted data m from the storing unit 3, and outputs the decrypted data m through the input/output interface 5 or the communication interface 6.

According to embodiment 1, the decrypted data 3544 corresponds to the result of the direct calculation of 1234⁷⁰⁶⁷ mod 10807. In addition, since a different first random number data si (s0, s1, s2 mentioned above) is generated with each cryptographic processing, the intermediate result of the above process is different each time, making it possible to realize a secure processing against the Differential Power Analysis (DPA).

Furthermore, with the cryptographic apparatus of embodiment 1, even when a circuit that performs data randomization to make the decryption of the secret key using the Differential Power Analysis (DPA) is provided, it is possible to avoid making the circuit scale large, since no circuit to perform a division process is used.

In addition, when a computer is used, the processing speed may be improved as well, since the division process is not performed.

Meanwhile, the method of embodiment 1 may also be applied when the Chinese Remainder Theorem (CRT) that is a high-speed processing method of the modular exponentiation operation.

embodiment 2 is explained.

embodiment 2 is a configuration in which the multiplication reminder operating unit 204 in embodiment 1 is a Montgomery multiplication reminder operating unit 701. In the cryptographic processing in embodiment 2, the Montgomery multiplication reminder operation is applied to the hardware explained in embodiment 1. The control unit 2 in embodiment 2 includes the processing unit 201 (processing circuit), the random number generating unit 202 (random number generating circuit), the modular exponentiation operating unit 203 (modular exponentiation operating circuit), the Montgomery multiplication reminder operating unit 701 (Montgomery multiplication reminder operation circuit) described later, and the like. The storing unit 3 stores pre-generated information, cryptographic processing information described later, and the like.

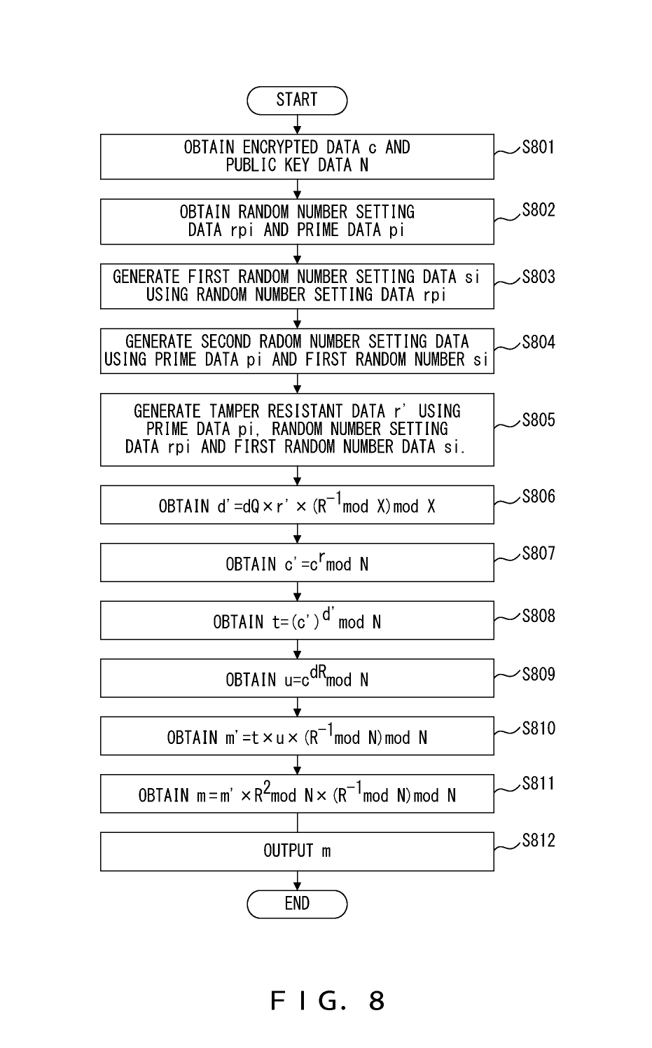

Meanwhile, various processing functions described later (for example, the flow illustrated in FIG. 8) may be realized by using a computer having the hardware configuration described above. The control unit 2 of embodiment 2 is explained.

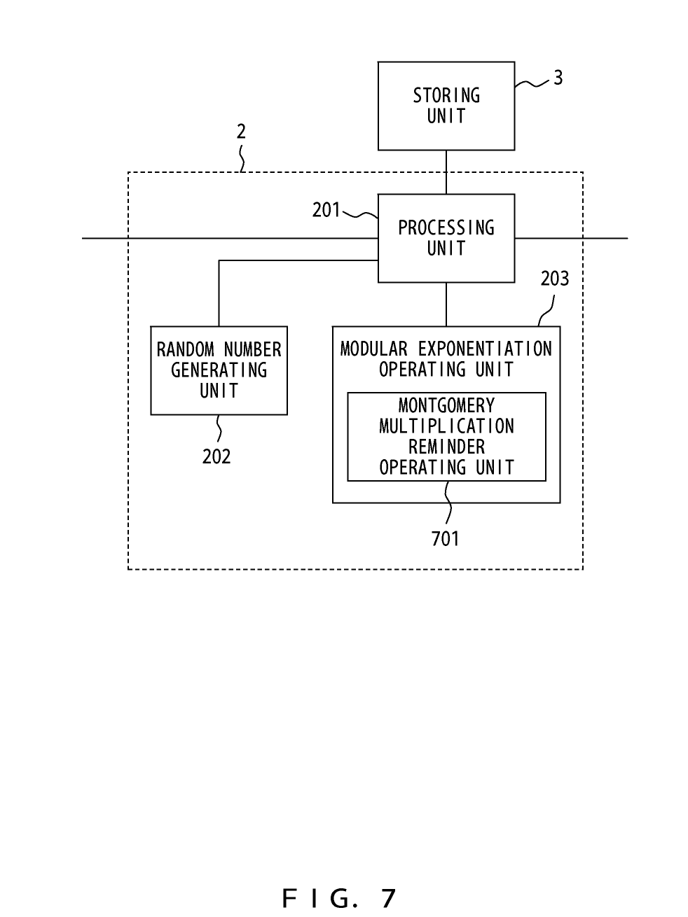

FIG. 7 is a diagram illustrating an example of the control unit of embodiment 2.

The processing unit 201 of FIG. 7 performs the same process as the processing unit 201 explained embodiment 1.

The random number generating unit 202 in FIG. 7 performs the same process as the random number generating unit 202 explained embodiment 1.

The modular exponentiation operating unit 203 in FIG. 7 obtains the variable c′ (the second variable) with the encrypted data c in the storing unit 2 as the base, the second random number data r as the exponent and the public key data N as the modulus. The variable c′ is obtained using expression 12 described later. Next, the modular exponentiation operating unit 203 stores the obtained variable c′ in the storing unit 3.

Meanwhile, the modular exponentiation operating unit 203 calculates the variable t (the third variable) with the variable c′ in the storing unit 3 as the base, the variable d′ as the exponent, and the public key data N as the modulus. The variable t is obtained using the expression 13 described later. Next, the modular exponentiation operating unit 203 stores the obtained variable t in the storing unit 3.

Meanwhile, the modular exponentiation operating unit 203 calculates the variable u (fourth variable) with the encrypted data c in the storing unit 3 as the base, the second key data dR as the exponent, and the public key data N as the modulus. The variable u is obtained using expression 14 described later. Next, the modular exponentiation operating unit 203 stores the obtained variable u in the storing unit 3.

The Montgomery multiplication reminder operating unit 701 (Montgomery multiplication reminder operation circuit) in FIG. 7 obtains the variable d′ (first variable) using the first key data dQ and the tamper resistant data r′ and X.

X is data representing 2^{(b1)}−1. Here, above-mentioned bl:the bit length of the modulus processable by the Montgomery multiplication reminder operating unit.

The variable d′ is obtained using expression 11 described later. Next, the Montgomery multiplication reminder operating unit 701 stores the obtained variable d′ in the storing unit 3.

Meanwhile, Montgomery multiplication reminder operating unit 701 obtains the variable m′ (fifth variable) using the variable t and the variable u and the public key data N in the storing unit 3. The variable m′ is obtained using expression 15. Next, the Montgomery multiplication reminder operating unit 701 stores the obtained variable m′ in the storing unit 3.

Meanwhile, the Montgomery multiplication reminder operating unit 701 obtains the decrypted data m using the variable m′ and R² and the public key data N in the storing unit 3. R² the square of the Montgomery parameter R. Next, the Montgomery multiplication reminder operating unit 701 stores the obtained decrypted data m in the storing unit 3.

The generating process in embodiment 2 is the same as the process explained in embodiment 1.

The cryptographic processing in embodiment 2 is explained.

FIG. 8 is a flow diagram illustrating an example of the operation of the cryptographic processing in embodiment 2.

In step S801, the processing unit 201 of the control unit 2 obtains the encrypted data c and the public key data N through the input/output interface 5 or the communication interface 6. For example, it is assumed that the encrypted data c=40239 and the public key data N=55687 are obtained. Next, the processing unit 201 stores the encrypted data c and the public key data N in the cryptographic processing information in the storing unit 3.

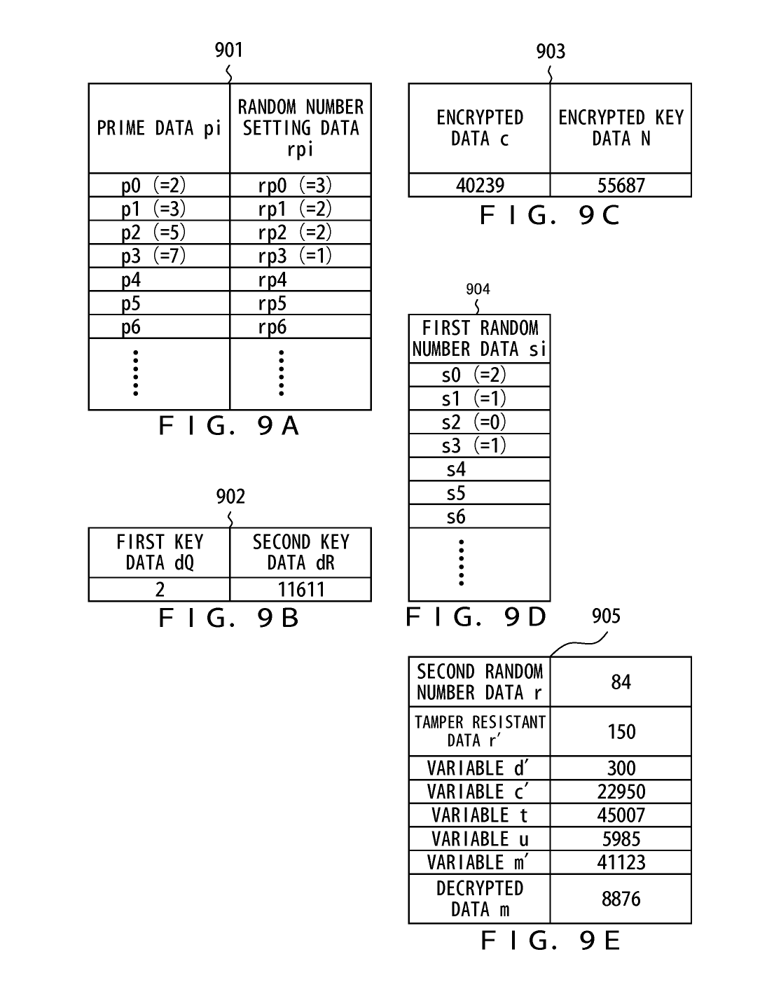

There may be a case in which c, N are stored in the storing unit 3 in advance. See cryptographic processing information 903 in FIG. 9C. FIG. 9A-FIG. 9E are diagrams illustrating an example of the data structure of the pre-generated information and the cryptographic processing information. The cryptographic processing information 903 in FIG. 9C includes information stored in “encrypted data c” “public key data N”. In this example, the encrypted data c “40239” and the public key data N “55687” are stored.

In step S802, the processing unit 201 of the control unit 2 obtains the random number setting data rpi and the prime data pi from the pre-generated information of the storing unit 3. For example, it is assumed that random number setting data rp0=3, rp1=2, rp2=2, rp3=1, prime datap0=2, p1=3, p2=5, p3=7 are obtained. See pre-generated information 901 in FIG. 9A. The pre-generated information 901 in FIG. 9A includes information stored in “prime data pi” “random number setting data rpi”. In “prime data pi” of the pre-generated information 901 in FIG. 9A, the prime data output in the generating process is stored, and in this example, “p0” “p1” “p2” “p3” “p4” “p5” “p6” . . . are stored. Meanwhile, (=2), (=3), (=5), (=7) indicated in “p0” “p1” “p2” “p3” the value of the four pieces of prime data p0-p3 described above, respectively. In “random number setting data rpi” of the pre-generated information 901 in FIG. 9A, the random number setting data output in the generating process is stored, and in this example, “rp0” “rp1” “rp2” “rp3” “rp4” “rp5” “rp6” . . . are stored. Meanwhile, (=3), (=2), (=2), (=1) indicated in “rp0” “rp1” “rp2” “rp3” represents the value of the four pieces of random number setting data rp0-rp3 described above, respectively.

In step S803, the random number generating unit 202 of the control unit 2 generates the first random number data si (i=0−n:n is a positive integer) using the random number setting data rpi. When the first random number generating unit 202 generates the first random number data si, the value with respect to each i for the first random number data si is supposed to satisfy 0≦si≦rpi. For example, when the random number setting data is rp0=3, rp1=2, rp2=2, rp3=1, it is possible that the first random number data is s0=2 (0≦s0≦3), s1=1 (0≦s1≦2), s2=0 (0≦s2≦2), s3=1 (0≦s2≦2). Next, the random number generating unit 202 stores the obtained the first random number data si in the storing unit 3 through the processing unit 201. See cryptographic processing information 904 in FIG. 9D. The cryptographic processing information 904 in FIG. 9D includes information stored in “the first random number data si”. In this example, “s0” “s1” “s2” “s3” “s4” “s5” “s6” . . . are stored. Meanwhile, (=2), (=1), (=0), (=1) indicated in “s0” “s1” “s2” “s3” represents the value of the four pieces of first random number data s0-s3 described above, for example.

In step S804, the random number generating unit 202 of the control unit 2 generates the second random number data r using the prime data pi and the first random number data si. The second random number data r is obtained using expression 9.

r=p0^{s0}×p1^{s1}×p2^{s2}× . . . ×pn^{sn} expression 9
r:the second random number data
pi:prime data
si: first random number data

For example, when the prime data is p0=2, p1=3, p2=5, p3=7, and the first random number data is s0=2, s1=1, s2=0, s3=1, the second random number data r is obtained by calculating 2²×3¹×5⁰×7¹=84. Next, the random number generating unit 202 stores the obtained second random number data r in the storing unit 3. See cryptographic processing information 905 in FIG. 9E. The cryptographic processing information 905 in FIG. 9E includes information stored in “second random number data r” “tamper resistant data r′” “variable d′” “variable c′” “variable t” “variable u” “variable m′” “decrypted data m”. In this example, “84” “150” “300” “22950” “45007” “5985” “41123” “8876” corresponding to “second random number data r” “tamper resistant data r′” “variable d′” “variable c′” “variable t” “variable u” “variable m′” “decrypted data m” are stored. In “second random number data r”, the second random number data r obtained in step S804 is stored. Information stored in each of “tamper resistant data r′” “variable d′” “variable c′” “variable t” “variable u” “variable m′” “decrypted data m” is described later.

In step S805, the random number generating unit 202 or the processing unit 201 obtains the tamper resistant data r′ using the prime data pi and the random number setting data rpi and the first random number data si. The tamper resistant data r′ is obtained using expression 10.

r′=p0^{rp0-s0}×p1^{rp1-s1}×p2^{rp2-s2}× . . . ×pn^{rpn-sn} expression 10
r′:tamper resistant data
pi:prime data
si:first random number data
rpi:random number setting data

For example, the case when the prime data is p0=2, p1=3, p2=5, p3=7, and the first random number data is s0=2, s1=1, s2=0, s3=1, and the random number setting data is rp0=3, rp1=2, rp2=2, rp3=1 is explained. The random number generating unit 202 or the processing unit 201, calculates 2³⁻²×3²⁻¹×5²⁻⁰×7¹⁻¹=150 to obtain the tamper resistant data r′. Next, the random number generating unit 202 or the processing unit 201 stores the obtained tamper resistant data r′ in the storing unit 3. In “tamper resistant data r′” of the cryptographic processing information 905 in FIG. 9E, “150” obtained in step S805 is stored.

In step S806, the Montgomery multiplication reminder operating unit 701 of the control unit 2 obtains the variable d′ using the first key data dQ and the tamper resistant data r′ in the storing unit 3. The variable d′ is obtained using expression 11.

d′=dQ×r′×(R⁻¹ mod X)mod X expression 11
dQ:the first key data
r′:tamper resistant data
R:Montgomery parameter
X:2^{(bl)}−1

Here, above-mentioned bl:the bit length of the modulus processable by the Montgomery multiplication reminder operating unit. For example, when the first key data dQ is 2, the tamper resistant data r′ is 150, and the bit length of the modulus (public key data N:modulus) processable by the Montgomery multiplication reminder operating unit 701 is 16 bits, the variable d′ is obtained by calculating 2×150×1 mod 0xFFFF=300. Here, the calculation result of (R⁻¹ mod X) is 1, and 0xFFFF is a number expressing 2¹⁶−1 in hexadecimal notation. Next, the Montgomery multiplication reminder operating unit 701 stores the obtained variable d′ in the storing unit 3. In “variable d′” of the cryptographic processing information 905 in FIG. 9E, “300” obtained in step S806 is stored.

Meanwhile, the first key data dQ is obtained from pre-generated information 902 in FIG. 9B. The pre-generated information 902 in FIG. 9B includes information stored in “first key data dQ” “the second key data dR”. In “first key data dQ” of the pre-generated information 902 in FIG. 9B, the first key data output in the generating process is stored, and in this example, “2” is stored. In “the second key data dR”, the second key data output in the generating process is stored, and in this example, “11611” is stored.

In step S807, the modular exponentiation operating unit 203 of the control unit 2 obtains the variable c′ using the encrypted data c and the second random number data r and public key data N in the storing unit 3. The variable c′ is obtained using expression 12.

c′=c^{r} mod N expression 12
c:encrypted data
r:the second random number data
N:public key data

For example, when the encrypted data c is 40239, the second random number data r is 84, and the public key data N is 55687, the modular exponentiation operating unit 203 obtains the variable c′ by calculating (40239)⁸⁴ mod 55687=22950. Next, modular exponentiation operating unit 203 stores the obtained variable c′ in the storing unit 3. In “variable c′” of the cryptographic processing information 905 in FIG. 9E, “22950” obtained in step S807 is stored.

In step S808, the modular exponentiation operating unit 203 of the control unit 2 obtains the variable t using the variable c′ and the variable d′ and the public key data N in the storing unit 3. The variable t is obtained using expression 13.

t=(c′)^{d′}mod N expression 13
N:public key data

For example, when the variable c′ is 22950, the variable d′300, and the public key data N is 55687, the modular exponentiation operating unit 203 obtains the variable t by calculating (22950)³⁰⁰ mod 55687=45007. Next, the modular exponentiation operating unit 203 stores the obtained variable t in the storing unit 3. In “variable t” of the cryptographic processing information 905 in FIG. 9E, “45007” obtained in step S808 is stored.

In step S809, the modular exponentiation operating unit 203 of the control unit 2 obtains the variable u using the encrypted data c and the second key data dR and the public key data N in the storing unit 3. The variable u is obtained using expression 14.

u=c^{dR} mod N expression 14
c:encrypted data
dR:the second key data
N:public key data

For example, when the encrypted data c is 40239, the second key data dR is 11611, and the public key data N is 55687, the modular exponentiation operating unit 203 obtains the variable u by calculating (40239)¹¹⁶¹¹ mod 55687=5985. Next, the modular exponentiation operating unit 203 stores the obtained variable u in the storing unit 3. In “variable u” of the cryptographic processing information 905 in FIG. 9E, “5985” obtained in step S809 is stored.

Here, the order of step S809 and S802-S808 may be changed.

In step S810, the Montgomery multiplication reminder operating unit 701 of the control unit 2 obtains the variable m′ using the variable t and the variable u and the public key data N in the storing unit 3. The variable m′ is obtained using expression 15.

m′=t×u×(R⁻¹ mod N)mod N expression 15
N:public key data
R:Montgomery parameter

For example, when the variable t is 45007, the variable u is 5985, the public key data N is 55687, and the Montgomery parameter R is 2¹⁶=0x10000 (hexadecimal), the Montgomery multiplication reminder operating unit 701 obtains variable m′. The variable m′ is obtained by calculating 45007×5985×21706 mod 55687=41123. Here, R⁻¹ (mod N) is 21706. Next, the Montgomery multiplication reminder operating unit 701 stores the obtained variable m′ in the storing unit 3. In “variable m′” of the cryptographic processing information 905 in FIG. 9E, “41123” obtained in step S810 is stored.

In step S811, the Montgomery multiplication reminder operating unit 701 of the control unit 2 obtains the decrypted data m using the variable m′ and R² mod N being the square of the Montgomery parameter and the public key data N in the storing unit 3. The decrypted data m is obtained using expression 16.

m=m′×R² mod N×(R⁻¹ mod N)mod N expression 16
N:public key data
R:Montgomery parameter

For example, when the variable m′ is 41123, the public key data N is 10807, and the Montgomery parameter R is 2¹⁶=0x10000 (hexadecimal), the decrypted data m is 8876. The Montgomery multiplication reminder operating unit 701 obtains the decrypted data m by calculating 41123×51734×21706 mod 55687=8876. R² mod N is 51734, and (R⁻¹ mod N) is 21706. Next, the Montgomery multiplication reminder operating unit 701 stores the obtained decrypted data m in the storing unit 3. The obtained “8876” in step S810 is stored in “decrypted data m” of cryptographic processing information 905 in FIG. 9E.

Here, regarding step S810, step S811, based on the commutativity of multiplication,

S810:m′=t×R²×(R⁻¹ mod N)mod N

S811:m=m′×u×(R⁻¹ mod N)mod N

or

S810:m=u×R²×(R⁻¹ mod N)mod N

S811:m=m′×t×(R⁻¹ mod N)mod N
the calculation may also be performed in an order such as the one described above.

In step S812, the control unit 2 obtains decrypted data m from the storing unit 3, and outputs the decrypted data m through the input/output interface 5 or the communication interface 6. Meanwhile, In the Montgomery multiplication reminder operation, (1)mod X and (2)R⁻¹ mod X appear in the calculation.

Then, regarding mod X in (1), a maximum such as 2²⁰⁴⁸−1, 2¹⁰²⁴−1, 2⁵¹²−1 that may be handled as X is used. That is, it is equal to the absence of mod X.

Regarding (2)R⁻¹ mod X, originally, d_{d}=d_{Q}×r′×(R⁻¹ mod X) mod X is calculated, and after that, in order to cancel out the effect of multiplication of R⁻¹ mod N, d_{d}×R² mod X×(R⁻¹ mod X) mod X=(d_{Q}×r′×R⁻¹) mod X×R² mod X×R⁻¹ mod X mod X=d_{Q}×r′ mod X is calculated in general, but when X=“the maximum value that may handled”, it follows that R⁻¹ mod X=1, there is no effect of the multiplication of R⁻¹ in the first place. Therefore, the operation to cancel out the effect is omitted. However, in steps S810 and S811, it is necessary that the calculation is performed not using mod X but using mod N.

According to embodiment 2, the encrypted data 8876 described above corresponds to the result of the direct calculation of 40239³⁶⁸¹¹ mod 55687. In addition, since different first random number data si (s0, s1, s2, s3 mentioned above) is generated with eacy cryptographic processing, it follows that the intermediate result of the above process is different each time, making it possible to realize a secure processing against the Differential Power Analysis (DPA).

Furthermore, with the cryptographic apparatus of embodiment 2, even when a circuit that performs data randomization to make the decryption of the secret key using the Differential Power Analysis (DPA) is provided, it is possible to avoid making the circuit scale large, since no circuit to perform a division process is used.

In addition, when a computer is used, the processing speed may be improved as well, since the division process is not performed.

Meanwhile, the method of embodiment 1 may also be applied when the Chinese Remainder Theorem (CRT) that is a high-speed processing method of the modular exponentiation operation.

The control unit 2 of embodiment 3 is explained.

Embodiment 3 is an application of a cryptographic processing to which the elliptic curve cryptography is applied, to the hardware in FIG. 1. In addition, the binary method is used in the scalar multiplication on a point on the elliptic curve. For example, when the private key d (secret key data) is 160 bits, and when the secret key data d is a very large number (for example, a number close to 2¹⁶⁰), the execution of the scalar multiplication involves a very large number of addition operation of a point and is unrealistic. Then, by using the binary method, the order of the amount of calculation of the scalar multiplication is kept to the order of the bit count of the secret key data d. In the binary method in the point scalar multiplication, the bit length of the secret key data d is assumed as u. In addition, the i-th bit of the secret key data d is described as d[i] (0≦i≦u−1). The lowest-order bit is d[0], and the highest-order bit is d[u−1]. Accordingly, the secret key data d of u bits is expressed as d[u−1]∥ . . . ∥d[1]∥d[0] as described above. Meanwhile, “∥” represents the connection of the bit strings. Then, dA=2^{u-1}d[u−1]A+ . . . +2¹d[1]A+20d[0]A is obtained, from d[u−1]∥ . . . ∥d[1] ∥d[0] and a point V=dA on the elliptic curve expressed by using a point A on the elliptic curve and the secret key data d.

In the binary method used in the scalar multiplication, the bit value d[i] of the secret key data d is scanned in the order from the higher-order bit to the lower-order bit. That is, the scan is performed in the order from i=u−1 to i=0, and according to the bit value d[i] of the secret key data d, when d[i]=1, after a doubling operation (v:=2×v), an addition (v:=v+A) is performed, and when d[i]=0, only the doubling operation (v:=2×v) is performed. Here, d[i] is the value of the i-th bit from the lowest order of d, where i≦0. Meanwhile, other than the binary method, a general scalar multiplication high-speed operation method such as the window method, the signed binary method, the signed window method and the like may also be used.

The control unit 2 the includes the processing unit 201 (processing circuit), the random number generating unit 202 (random number generating circuit), a point scalar multiplication 1001 (point scalar multiplication operating circuit), a point addition operating unit 1002 (point addition operating circuit), a multiplication unit 1003 (multiplication circuit) described later, and the like. The storing unit 3 stores pre-generated information, cryptographic processing information and the like described later.

The multiplication unit 1003 may be included in the point scalar multiplication unit. In addition, instead of the multiplication unit, a Montgomery multiplication reminder operating unit may be included.

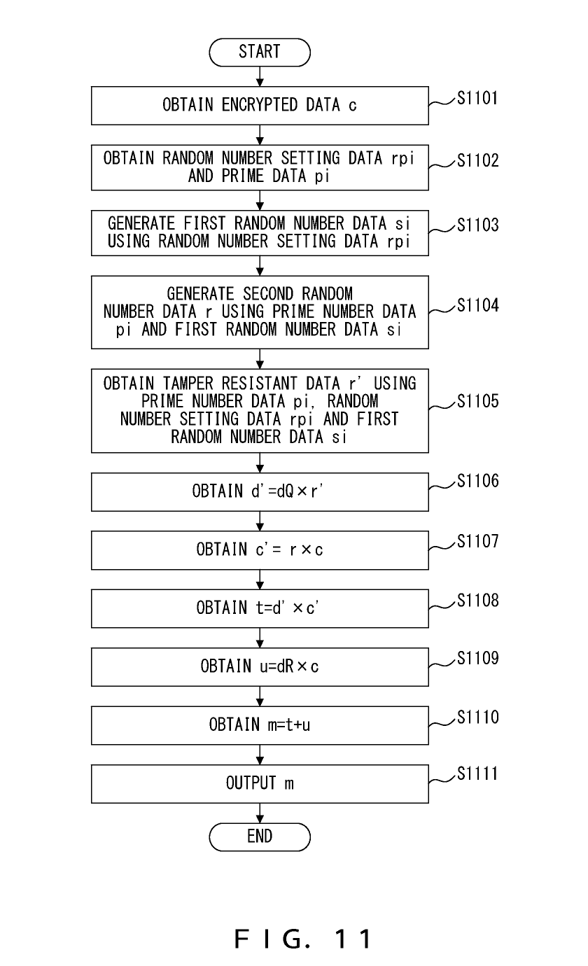

In addition, various processing functions described later (for example, the flow illustrated in FIG. 11) may be realized by using a computer having the hardware configuration described above.

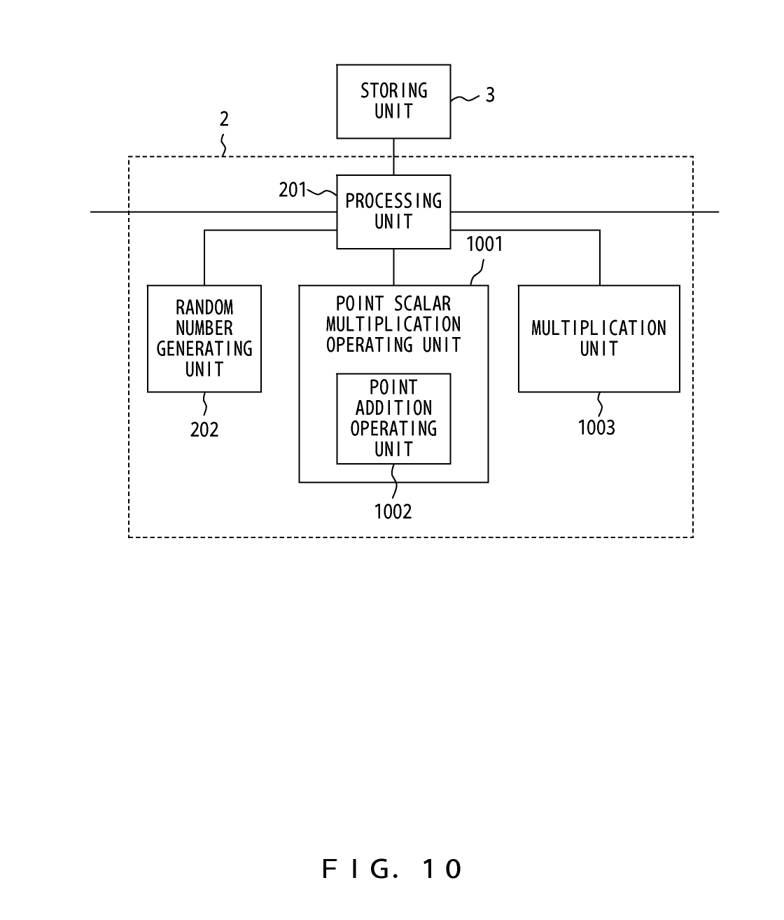

FIG. 10 is a diagram illustrating an example of the control unit of embodiment 3.

The processing unit 201 in FIG. 10 performs the same process as the processing unit 201 explained in embodiments 1 and 2.

The random number generating unit 202 in FIG. 10 performs the same process as the random number generating unit 202 explained in embodiments 1 and 2.

The point scalar multiplication 1001 (point scalar multiplication operating circuit) in FIG. 10 obtains the variable c′ (the second variable) using the encrypted data c and the second random number data r in the storing unit 3. The variable c′ is obtained using expression 20 described later. Next, the point scalar multiplication operating unit 1001 stores the obtained variable c′ in the storing unit 3.

Meanwhile, the point scalar multiplication operating unit 1001 obtains the variable t (the third variable) using the variable c′ and the variable d′ in the storing unit 3. The variable t is obtained using express ion 21 described later. Next, the point scalar multiplication operating unit 1001 stores the obtained variable t in the storing unit 3.

Meanwhile, the point scalar multiplication operating unit 1001 obtains the variable u (the fourth variable) using the encrypted data c and the second key data dR in the storing unit 3. The variable u is obtained using expression 22 described later. Next, the point scalar multiplication operating unit 1001 stores the obtained variable u in the storing unit 3.

The point scalar multiplication is an operation to calculate a point on the elliptic curve V given by V=dA from a point A on the elliptic curve, a scalar value d. This is performed by combining point addition, point subtraction, point doubling operation, and is a basic operation method in the elliptic curve cryptography.

The elliptic curve is explained. The relational representation of x,y presented below is called an elliptic curve. The elliptic curve mainly consists of two types, the prime field and the exponent of 2. Parameters a, b for uniquely determining the elliptic curve is called elliptic curve parameters.
elliptic curve (prime field):y²=x³+ax+b(mod p)
   p:prime
   a, b:elliptic curve parameter (0≦a, b<p)
elliptic curve (exponent of 2):y+xy=x³+ax²+b(mod f(x))
   F:polynomial expression of GF(2^{m})
   a, b:elliptic curve parameter (a, b⊂ GF(2^{m})).

A point on the elliptic curve is (x,y) that satisfies the relational expression expressed by the elliptic curve, and is a set of integers x,y where 0≦x,y< in the case of the prime field, and is a set of elements x,y that satisfies x,y⊂GF(2^{m}) in the case of the exponent of 2. In addition, regarding the point A expressed by A=(x,y), x is called the x coordinate of the point A, and y is called the y coordinate of y, respectively. In addition, one of points on the elliptic curve is a special point called a point at infinity. The expression “a point on the elliptic curve” may be simplified and may be expressed as a point. Here, a point at infinity is a special point on the elliptic curve, and is described as O. Regarding a given point A, A+O=O+A=A is satisfied. Here, + represents the point addition. For the detailed definition, see standards such as IEEE P1363 and the like.

The base point is one of points on the elliptic curve, and is described as G. Used in a shared manner between users of the elliptic curve cryptography, and is used in the public key/private key pair generation and various functions using the elliptic curve cryptography. For the detailed definition, see standards such as IEEE P1363 and the like.

With the point addition, a point C on the elliptic curve expressed by C=A+B based on points A, B is defined. This operation of A+B is called the point addition. C may be calculated from the x,y coordinates of A, B and the elliptic curve parameter. Meanwhile, to this operation, the commutative law, that is, A+B=B+A holds true. For details of this operation, see standards such as Institute of Electrical and Electronic Engineers (IEEE)P1363. Meanwhile, with the point subtraction, the point C on the elliptic curve expressed by C=A-B based on points A, B, is defined. This operation of A−B is called the point subtraction. C may be calculated from the x,y coordinates of A, B and the elliptic curve parameter. Meanwhile, with the point doubling operation, the point C on the elliptic curve expressed by C=2A is defined, based on the points A, B, from the point A on the elliptic curve. This operation of 2A is called the point doubling operation. C may be calculated from the x,y coordinates of A and the elliptic curve parameter, using arithmetic operation.

Meanwhile, for the public key in the elliptic curve cryptography, with respect to the base point G, the scalar value d expressing the private key, the public key is given by V that satisfies V=dG. That is, the public key is a point on the elliptic curve, and the private key is the scalar value.

Next, the point addition operating unit 1002 (point addition operating circuit) in FIG. 10 obtains the decrypted data m using the variable t and the variable u in the storing unit 3. The decrypted data m is obtained using expression 23 described later. Next, the point addition operating unit 1002 stores the obtained decrypted data m in the storing unit 3.

The multiplication unit 1003 (multiplication circuit) in FIG. 10 obtains the variable d′ (the first variable) using the first key data dQ and the tamper resistant data r′ in the storing unit 3. The variable d′ is obtained using expression 19 described later. Next, the multiplication unit 1003 stores the obtained variable d′ in the storing unit 3.

The generating process in embodiment 3 is the same as the process explained in embodiment 1. The cryptographic processing in embodiment 3 is explained.

FIG. 11 is a flow diagram illustrating an example of the operation of the cryptographic processing in embodiment 3.

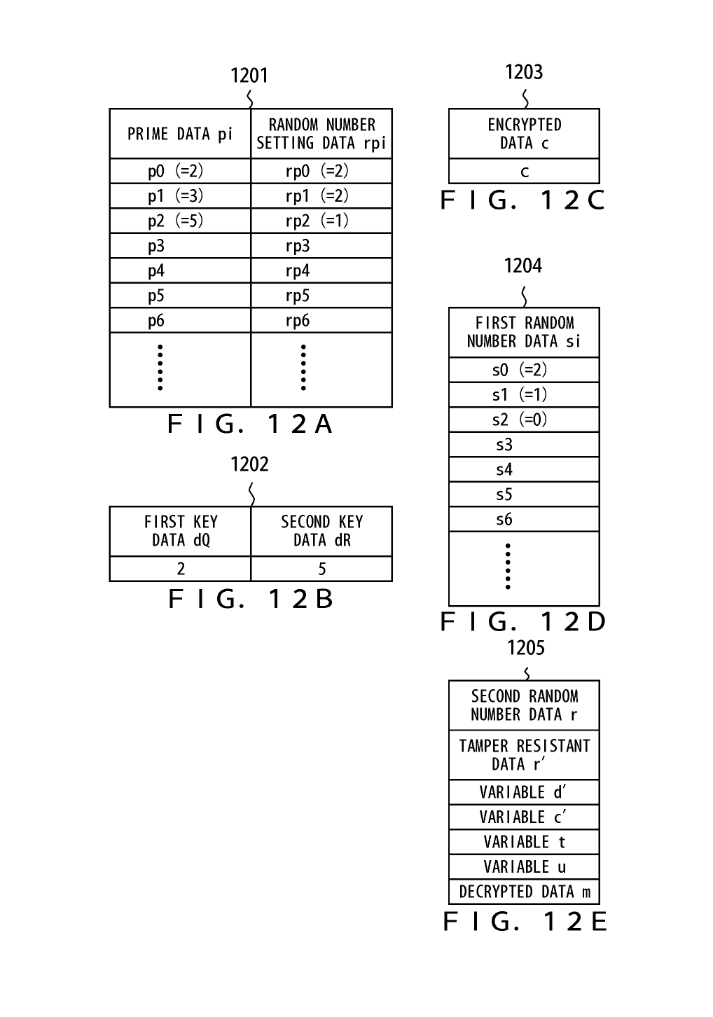

In step S1101, the processing unit 201 of the control unit 2 obtains the encrypted data c through the input/output interface 5 or the communication interface 6. Next, the processing unit 201 stores the encrypted data c in the cryptographic processing information in the storing unit 3. Meanwhile, there may be a case in which the encrypted data c is stored in the storing unit 3 in advance. See the cryptographic processing information 1203 in FIG. 12C. FIG. 12A-12E are diagrams illustrating an example of the data structure of the pre-generated information and cryptographic processing information in embodiment 3. The cryptographic processing information 1203 in FIG. 12C includes information stored in “encrypted data c”. In this example, the encrypted data c “c” explained above is stored.

In step S1102, the processing unit 201 of the control unit 2 obtains the random number setting data rpi and the prime data pi from the pre-generated information in the storing unit 3. For example, it is assumed that the random number setting data rp0=2, rp1=2, rp2=1, the prime data p0=2, p1=3, p2=5 are obtained. See the pre-generated information 1201 in FIG. 12A. The pre-generated information 1201 in FIG. 12A includes information stored in “prime data pi” “random number setting data rpi”. In “prime data pi” of the pre-generated information 1201 in FIG. 12A, the prime data output in the generating process is stored, and in this example, “p0” “p1” “p2” “p3” “p4” “p5” “p6” . . . are stored. Meanwhile, (=2), (=3), (=5) indicated in “p0” “p1” “p2” represent the value of the three pieces of prime data p0-p2 described above, respectively. In “random number setting data rpi” of the pre-generated information 1201 in FIG. 12A, the random number setting data output in the generating process is stored, and in this example, “rp0” “rp1” “rp2” “rp3” “rp4” “rp5” “rp6” . . . are stored. Meanwhile, (=2), (=2), (=1) indicated in “rp0” “rp1” “rp2” represent the value of the three pieces of random number setting data rp0-rp2 described above, respectively.

In step S1103, the random number generating unit 202 of the control unit 2 generates the first random number data si (i=0-n:n is a positive integer) using the random number setting data rpi. When the first random number generating unit 202 generates the first random number data si, the value with respect to each i for the first random number data si is supposed to satisfy 0≦si≦rpi. For example, when the random number setting data is rp0=2, rp1=2, rp2=1, the first random number data s0=2(0≦s0≦2), s1=1(0≦s1≦2), s2=0(0≦s2≦1) are possible. Next, the random number generating unit 202 stores the obtained first random number data si in the storing unit 3 through the processing unit 201. See the cryptographic processing information 1204 in FIG. 12D. The cryptographic processing information 1204 in FIG. 12D includes information stored in “the first random number data si”. In this example, “s0” “s1” “s2” “s3” “s4” “s5” “s6” . . . are stored. Meanwhile, (=2), (=1), (=0) indicated in “s0” “s1” “s2” represent the value of the three pieces of first random number data s0-s2 described above, respectively.

In step S1104, the random number generating unit 202 of the control unit 2 obtains the second random number data r using the prime data pi and the first random number data si. The second random number data r is obtained using expression 17.

r=p0^{s0}×p1^{s1}×p2^{s2}× . . . ×pn^{sn} expression 17
r:the second random number data
pi:prime data
si:first random number data

For example, when the prime data is p0=2, p1=3, p2=5, and the first random number data is s0=2, s1=1, s2=0, the second random number data r is calculated by 2²×3¹×5⁰=12. Next, the random number generating unit 202 stores the obtained second random number data r in the storing unit 3. Seethe cryptographic processing information 1205 in FIG. 12E. The cryptographic processing information 1205 in FIG. 12E includes information stored in “second random number data r” “tamper resistant data r′” “variable d′” “variable c′” “variable t” “variable u” “decrypted data m”. In this example, “12” “15” “30” “12c” “360c” “5c” “365c” corresponding to “second random number data r” “tamper resistant data r′” “variable d′” “variable c′” “variable t” “variable u” “decrypted data m” are stored. In “second random number data r”, the second random number data r obtained in step S1104 is stored. Information stored in each of “tamper resistant data r′” “variable d′” “variable c′” “variable t” “variable u” “decrypted data m” is described later.

In step S1105, the random number generating unit 202 or the processing unit 201 generates the tamper resistant data r′ using the prime data pi, the random number setting data rpi and the first random number data si. The tamper resistant data r′ is obtained using expression 18.

r′=p0^{rp0-s0}×p1^{rp1-s1}×p2^{rp2-s2}× . . . ×pn^{rpn-sn} expression 18
r′:tamper resistant data
pi:prime data
si:first random number data
rpi:random number setting data

For example, a case in which the prime data is p0=2, p1=3, p2=5, the first random number data is s0=2, s1=1, s2=0, and the random number setting data is rp0=2, rp1=2, rp2=1 is explained. The random number generating unit 202 or the processing unit 201 obtains the tamper resistant data r′ by calculating 2²⁻²×3²⁻¹×5¹⁻⁰=15. Next, the random number generating unit 202 or the processing unit 201 stores the obtained tamper resistant data r′ in the storing unit 3. In “tamper resistant data r′” of the cryptographic processing information 1205 in FIG. 12E, “15” obtained in step S1105 is stored.

In step S1106, the multiplication unit 1003 of the control unit 2 obtains the variable d′ using the first key data dQ and the tamper resistant data r′. The variable d′ is obtained using expression 19.

d′=dQ×r′ expression 19
dQ:the first key data
r′:tamper resistant data

For example, when the first key data dQ is 2, and the tamper resistant data r′ is 15, the multiplication unit 1003 obtains the variable d′ by calculating 2×15=30. Next, the multiplication unit 1003 stores the obtained variable d′ in the storing unit 3. In “variable d′” of the cryptographic processing information 1205 in FIG. 12E, “30” obtained step S1106 is stored.

When a Montgomery multiplication reminder operating unit is provided instead of the multiplication unit, the calculation is performed as d′=dQ×r′×(R⁻¹ mod X)mod X.

X is data representing 2^{(bs)}−1 X. Here, above-mentioned bs:the bit size processable by the Montgomery multiplication reminder operating unit.

Meanwhile, the first key data dQ is obtained from the pre-generated information 1202 in FIG. 12B in the storing unit 3. The pre-generated information 1202 in FIG. 12B includes information stored in “first key data dQ” “the second key data dR”. In “first key data dQ” in the pre-generated information 1202 in FIG. 12B, the first key data output in the generating process is stored, and in this example, “2” is stored. In “the second key data dR”, the second key data output in the generating process is stored, and in this example, “5” is stored.

In step S1107, The point scalar multiplication operating unit 1001 of the control unit 2 obtains the variable c′ using the encrypted data c and the second random number data r. The variable c′ is obtained using expression 20.

c′=c×r expression 20
c:encrypted data
r:the second random number data

For example, when the encrypted data is expressed as c, in the case in which the second random number data r is 12, the point scalar multiplication operating unit 1001 obtains the variable c′ by calculating 12×c. Next, the point scalar multiplication operating unit 1001 stores the obtained variable c′ in the storing unit 3. In “variable C′” of the cryptographic processing information 1205 in FIG. 12E, “12c” obtained in step S1107 is stored.

In step S1108, the point scalar multiplication operating unit 1001 in control unit 2 obtains the variable t using the variable c′ and the variable d′ in the storing unit 3. The variable t is obtained using expression 21.

t=d′×c′ expression 21

For example, when variable c′ is 12c, and the variable d′ is 30, the point scalar multiplication operating unit 1001 obtains the variable t by calculating 30×12c=360c. Next, the point scalar multiplication operating unit 1001 stores the obtained variable t in the storing unit 3. In “variable t” of the cryptographic processing information 1205 in FIG. 12E, “360c” obtained in step S1208.

In step S1109, the point scalar multiplication operating unit 1001 in the control unit 2 obtains the variable u using the encrypted data c and the second key data dR in the storing unit 3. The variable u is obtained using expression 22.

u=c×dR expression 22
c:encrypted data
dR:the second key data

For example, when the encrypted data c is c, and the second key data dR is 5, the point scalar multiplication operating unit 1001 obtains the variable u by calculating 5×c=5c. Next, the point scalar multiplication operating unit 1001 stores the obtained variable u in the storing unit 3. In “variable u” of the cryptographic processing information 1205 in FIG. 12E, “5c” obtained in S1109 is stored.

Here, the order of step S1109 and steps S1102-S1108 may be changed.

In step S1110, the point addition operating unit 1002 of the control unit 2 obtains the decrypted data m using the variable t and the variable u in the storing unit 3. The decrypted data m is obtained using expression 23.

m=t+u expression 23

For example, when the variable t is 360c, and the variable u is 5c, the point addition operating unit 1002 obtains the decrypted data m by calculating 360c+5c=365c. Next, the point addition operating unit 1002 stores the decrypted data m in the storing unit 3. In “decrypted data m” in the cryptographic processing information 1205 in FIG. 12E, “365c” obtained in step S1110 is stored.

In step S1111, the control unit 2 obtains the decrypted data m from the storing unit 3, and outputs the decrypted data m through input/output interface 5 or the communication interface 6.

According to embodiment 3, the decrypted data 365c corresponds to the result of the direct calculation of the scalar value dxencrypted data c. In addition, since different first random number data si (s0, s1, s2 mentioned above) is generated with every cryptographic processing, it follows that the intermediate result of the above process is different each time, making it possible to realize a secure processing against the Differential Power Analysis (DPA).

Furthermore, with the cryptographic apparatus of embodiment 3, even when a circuit that performs data randomization to make the decryption of the secret key using the Differential Power Analysis (DPA) is provided, it is possible to avoid making the circuit scale large, since no circuit to perform a division process is used.

In addition, when a computer is used, the processing speed may be improved as well, since the division process is not performed.

In addition, the present invention is not limited to embodiments 1, 2, 3 described above, and various improvements, changes may be made without departing from the spirit and scope of the invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments) of the present invention have been described in detail, it should be understood that the various changes, substitutions, and alterations could be made hereto without departing from the spirit and scope of the invention.

What is claimed is:

1. A cryptographic apparatus configured to obtain decrypted data by performing an modular exponentiation operation using encrypted data representing a base, secret key data representing an exponent and public key data representing a modulus, comprising:
a storing unit configured to store first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data;
a random number generating unit configured to obtain second random number data by exponentiating the respective prime data, using respective first random number data being positive integers equal to or smaller than the random number setting data representing exponents corresponding to the respective prime data and by multiplying the respective obtained exponentiated data, and configured to obtain tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data; and
an modular exponentiation operating unit configured to obtain a first variable by performing a multiplication reminder operation using the first key data and the tamper resistant data as a base with data obtained by subtracting 1 from a maximum bit width length that may be handled in the multiplication reminder operation as a modulus or to obtain the first variable by multiplication of the first key data and the tamper resistant data, configured to obtain a second variable by performing a modular exponentiation operation with the encrypted data as a base, with the second random number data as an exponent and with the public key data as a modulus, and configured to obtain a third variable by performing a modular exponentiation operation with the second variable as a base, with the first variable as an exponent, and with the public key data as a modulus, configured to obtain a fourth variable by performing a modular exponentiation operation with the encrypted data as a base, with the second key data as an exponent, and with the public key data as a modulus, and configured to obtain the decrypted data by performing a multiplication reminder operation with the third variable and the fourth variable as a base and with the public key data as a modulus.

2. The cryptographic apparatus according to claim 1, wherein
the modular exponentiation operating unit
obtains the first variable by performing a Montgomery multiplication reminder operation using the first key data and the tamper resistant data as a base with data obtained by subtracting 1 from 2 raised to the power of a maximum bit width length that may be handled in the Montgomery multiplication reminder operation as a modulus, and obtains a fifth variable by performing a Montgomery multiplication reminder operation using the third variable and the fourth variable as a base and with the public key data as a modulus; and
obtains the encrypted data by performing a Montgomery multiplication reminder operation using the fifth variable and a square of a Montgomery parameter as a base with the public key data as a modulus.

3. A cryptographic apparatus configured to obtain decrypted data by performing a point scalar multiplication operation using encrypted data, secret key data and public key data, comprising:
a storing unit configured to store first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data;
a random number generating unit configured to obtain second random number data by exponentiating the respective prime data, using respective first random number data being positive integers equal to or smaller than the random number setting data representing exponents corresponding to the respective prime data and by multiplying the respective obtained exponentiated data, and configured to obtain tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data; and
a multiplication unit configured to obtain a first variable by performing a multiplication using the first key data and the tamper resistant data; and
a point scalar multiplication operating unit configured to obtain a second variable by performing a point scalar multiplication operation using the encrypted data and the second random number data, configured to obtain a third variable by performing a point scalar multiplication using the second variable and the first variable, configured to obtain a fourth variable by performing a point scalar multiplication using the encrypted data and the second key data, and configured to obtain decrypted data by performing a point addition operation using the third variable and the fourth variable.

4. A cryptographic processing method executed by a computer, comprising:
storing in a storing unit first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data;
obtaining second random number data by exponentiating the respective prime data, using respective first random number data being positive integers equal to or smaller than the random number setting data representing exponents corresponding to the respective prime data and by multiplying the respective obtained exponentiated data;
obtaining tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data;
obtaining a first variable by performing a multiplication reminder operation using the first key data and the tamper resistant data as a base with data obtained by subtracting 1 from a maximum bit width length that may be handled in the multiplication reminder operation as a modulus or to obtain the first variable by multiplication of the first key data and the tamper resistant data;
obtaining a second variable by performing a modular exponentiation operation with the encrypted data as a base, with the second random number data as the exponent and with the public key data as a modulus;
obtaining a third variable by performing a modular exponentiation operation with the second variable as a base, with the first variable as an exponent, and with the public key data as a modulus;
obtaining a fourth variable by performing a modular exponentiation operation with the encrypted data as a base, with the second key data as an exponent, and with the public key data as a modulus; and
obtaining encrypted data by performing a multiplication reminder operation using the third variable and the fourth variable as a base, and with the public key data as a modulus.

5. The cryptographic processing method according to claim 4, wherein
the computer
obtains the first variable by performing a Montgomery multiplication reminder operation using the first key data and the tamper resistant data as a base with data obtained by subtracting 1 from 2 raised to the power of a maximum bit width length that may be handled in the Montgomery multiplication reminder operation as a modulus;
obtains a fifth variable by performing a Montgomery multiplication reminder operation using the third variable and the fourth variable as a base and with the public key data as a modulus; and
obtains the encrypted data by performing a Montgomery multiplication reminder operation using the fifth variable and a square of the Montgomery parameter as a base with the public key data as a modulus.

6. A cryptographic processing method executed by a computer, comprising:
storing in a storing unit first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data;
obtaining second random number data by exponentiating the respective prime data, using respective first random number data being positive integers equal to or smaller than the random number setting data representing exponents corresponding to the respective prime data and by multiplying the respective obtained exponentiated data;
obtaining tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data;
obtaining a first variable by performing a multiplication using the first key data and the tamper resistant data;
obtaining a second variable by performing a point scalar multiplication operation using the encrypted data and the second random number data;
obtaining a third variable by performing a point scalar multiplication using the second variable and the first variable;
obtaining a fourth variable by performing a point scalar multiplication using the encrypted data and the second key data; and
obtaining decrypted data by performing a point addition operation using the third variable and the fourth variable.

7. A computer-readable recording medium having stored there in a cryptographic program for causing a computer to execute a cryptographic process comprising:
storing in a storing unit first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data;
obtaining second random number data by exponentiating the respective prime data, using respective first random number data being positive integers equal to or smaller than the random number setting data representing exponents corresponding to the respective prime data and by multiplying the respective obtained exponentiated data;
obtaining tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data;
obtaining a first variable by performing a multiplication reminder operation using the first key data and the tamper resistant data as a base with data obtained by subtracting 1 from a maximum bit width length that may be handled in the multiplication reminder operation as a modulus or to obtain the first variable by multiplication of the first key data and the tamper resistant data;
obtaining a second variable by performing a modular exponentiation operation with the encrypted data as a base, with the second random number data as the exponent and with the public key data as a modulus;
obtaining a third variable by performing a modular exponentiation operation with the second variable as a base, with the first variable as an exponent, and with the public key data as a modulus;
obtaining a fourth variable by performing a modular exponentiation operation with the encrypted data as a base, with the second key data as an exponent, and with the public key data as a modulus; and
obtaining encrypted data by performing a multiplication reminder operation using the third variable and the fourth variable as a base, and with the public key data as a modulus.

8. The cryptographic program according to claim 7, wherein
the computer executes processes of
obtaining the first variable by performing a Montgomery multiplication reminder operation using the first key data and the tamper resistant data as a base with data obtained by subtracting 1 from 2 raised to the power of a maximum bit width length that may be handled in the Montgomery multiplication reminder operation as a modulus;
obtaining a fifth variable by performing a Montgomery multiplication reminder operation using the third variable and the fourth variable as a base and with the public key data as a modulus; and
obtaining the encrypted data by performing a Montgomery multiplication reminder operation using the fifth variable and a square of the Montgomery parameter as a base with the public key data as a modulus.

9. A computer-readable recording medium having stored there in a cryptographic program for causing a computer to execute a cryptographic process comprising:
storing in a storing unit first key data and second key data in advance, the first key data representing a quotient obtained by exponentiating respective prime data, using respective random number setting data representing an exponent corresponding to the respective prime data, by obtaining multiplication data by multiplying the respective obtained exponentiated data, and then by dividing the secret key data by the multiplication data, the second key data representing a reminder obtained by dividing the secret key data by the multiplication data;
obtaining second random number data by exponentiating the respective prime data, using respective first random number data being positive integers equal to or smaller than the random number setting data representing exponents corresponding to the respective prime data and by multiplying the respective obtained exponentiated data;
obtaining tamper resistant data by exponentiating the respective prime data, using subtraction data obtained by subtracting the first random number data corresponding to the random number setting data from the random number setting data representing exponents corresponding to the respective prime data and by multiplying the respective obtained exponentiated data;
obtaining a first variable by performing a multiplication using the first key data and the tamper resistant data;
obtaining a second variable by performing a point scalar multiplication operation using the encrypted data and the second random number data;
obtaining a third variable by performing a point scalar multiplication using the second variable and the first variable;
obtaining a fourth variable by performing a point scalar multiplication using the encrypted data and the second key data; and
obtaining decrypted data by performing a point addition operation using the third variable and the fourth variable.
